(19) United States
(12) Patent Application Publication
(10) Pub. No.: US 2019/0074128 A1
(43) Pub. Date: Mar. 7, 2019

(54) MAGNETIC SHEET AND ELECTRONIC DEVICE

(71) Applicant: Samsung Electro-Mechanics Co., Ltd., Suwon-si (KR)

(72) Inventors: Seung Min LEE, Suwon-si (KR); Sang Kyun KWON, Suwon-si (KR); Jung Young CHO, Suwon-si (KR); Ji Hyo LEE, Suwon-si (KR)

(73) Assignee: Samsung Electro-Mechanics Co., Ltd., Suwon-si (KR)

(21) Appl. No.: 15/987,076

(22) Filed: May 23, 2018

(30) Foreign Application Priority Data
Sep. 4, 2017 (KR) 10-2017-0112572

(51) Int. Cl. H01F 27/245; H01F 27/28; H01F 1/16; H01F 38/14; H02J 50/10; C22C 38/12; C22C 38/02; C22C 38/00; C22C 38/16; C22C 38/14

(52) U.S. Cl. CPC H01F 27/245; H01F 27/2804; H01F 1/16; H01F 38/14; H02J 50/10; C22C 2202/02; C22C 38/02; C22C 38/002; C22C 38/16; C22C 38/14; C22C 38/12

(57) ABSTRACT

A magnetic sheet includes a magnetic made of an Fe-based alloy, wherein the magnetic layer includes a first surface region and a second surface region opposing each other in a thickness direction of the magnetic layer, and an internal region disposed between the first surface region and the second surface region, and a crystallinity of the first surface region is higher than a crystallinity of the second surface region.

### CROSS-REFERENCE TO RELATED APPLICATIONS

This application claims the benefit under 35 USC 119(a) of Korean Patent Application No. 10-2017-0112572 filed on Sep. 4, 2017, in the Korean Intellectual Property Office, the entire disclosure of which is incorporated herein by reference for all purposes.

### BACKGROUND

### 1. Field

The following description relates to a magnetic sheet and an electronic device.

### 2. Description of Related Art

Recently, a Wireless Power Consortium (WPC) function, a Near Field Communication (NFC) function, and a Magnetic Secure Transmission (MST) function have been provided in mobile and portable devices. WPC technology, NFC technology, and MST technology have different operation frequencies, different data rates, and different amounts of transmitted power.

A wireless power receiving apparatus includes a magnetic sheet that blocks and concentrates a magnetic field. For example, the magnetic sheet is disposed between a wireless power reception coil and a battery. The magnetic sheet concentrates a magnetic field generated in the wireless power reception coil by a magnetic field received from a wireless power transmitting apparatus, and blocks the magnetic field generated in the wireless power reception coil from reaching the battery, thereby enabling wireless power in the form of electromagnetic waves to be efficiently transmitted from the wireless power transmitting apparatus to the wireless power receiving apparatus.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a magnetic sheet includes a magnetic layer made of an Fe-based alloy, wherein the magnetic layer includes a first surface region and a second surface region opposing each other in a thickness direction of the magnetic layer, and an internal region disposed between the first surface region and the second surface region, and a crystallinity of the first surface region is higher than a crystallinity of the second surface region.

A crystallinity of the internal region may be different from the crystallinity of the first surface region and the crystallinity of the second surface region.

A crystallinity of the internal region may be higher than the crystallinity of the second surface region.

The crystallinity of the first surface region may be higher than the crystallinity of the internal region.

A crystallinity of the magnetic sheet may gradually increase from the second surface region to the first surface region.

The Fe-based alloy may be represented by a composition formula of FexBySizMαAβ in which M is at least one element selected from the group consisting of Nb, V, W, Ta, Zr, Hf, Ti, P, C, and Mo, A is at least one element selected from the group consisting of Cu and Au, and x, y, and z expressed in atomic % satisfy the conditions 75%≤x≤90%, 7%≤y≤13%, and 4%≤z≤12%.

In the first surface region, a peak of a (200) plane may be greater than a peak of a (110) plane in an X-ray diffraction (XRD) analysis graph.

In the first surface region, a main peak may appear at the (200) plane in the XRD analysis graph.

In the second surface region, a peak of a (110) plane may be greater than a peak of a (200) plane in an X-ray diffraction (XRD) analysis graph.

In the second surface region, a main peak may appear at the (110) plane in the XRD analysis graph.

The first surface region may have a mixed phase structure of crystal phases and an amorphous phase, and the second surface region may have a substantially single phase structure of an amorphous phase.

The magnetic layer may have a fragmented surface including a plurality of cracks.

Each of the plurality of cracks may include a plurality of fragments.

The fragmented surface may be a surface of the first surface region.

In another general aspect, an electronic device includes a coil; and a magnetic sheet disposed adjacent to the coil and including a magnetic layer made of an Fe-based alloy, wherein the magnetic layer includes a first surface region and a second surface region opposing each other in a thickness direction of the magnetic layer, and an internal region disposed between the first surface region and the second surface region, and a crystallinity of the first surface region is higher than a crystallinity of the second surface region.

The magnetic sheet may be disposed so that the first surface region faces toward the coil.

In another general aspect, a magnetic sheet includes a magnetic layer made of an Fe-based alloy and including a mixture of crystal phases and an amorphous phase, wherein a ratio of a total area of the crystal phases to an area of the amorphous phase in a cross-sectional area of the magnetic layer changes in a thickness direction of the magnetic layer.

The magnetic layer may include a first surface region and a second surface region opposing each other in the thickness direction of the magnetic layer, and an internal region disposed between the first surface region and the second surface region, and the ratio may gradually decrease from the first surface region of the magnetic layer to the second surface region.

The magnetic sheet may be constituted by a single one of the magnetic layer.

The magnetic sheet may be constituted by a plurality of the magnetic layer.

In another general aspect, a magnetic sheet includes a magnetic layer made of an Fe-based alloy including a first surface region and a second surface region opposing each other in a thickness direction of the magnetic layer, and an internal region disposed between the first surface region and the second surface region, wherein a highest peak in an X-ray diffraction (XRD) analysis graph for the first surface region occurs at a first plane, a highest peak in an XRD analysis graph for the second surface region occurs at a second crystalline plane different from the first plane, and the peak of the first plane in the first surface region is higher than the peak of the second plane in the second surface region.

The peak of the first plane in the first surface region may be at least 5 times higher than the peak of the second plane in the second surface region.

A crystallinity of the magnetic layer may gradually decrease from the first surface region to the second surface region.

A saturation magnetic flux density and a magnetic permeability of the first surface region are higher than a saturation magnetic flux density and a magnetic permeability of the internal region and a saturation magnetic flux density and a magnetic permeability of the second surface region.

Other features and aspects will be apparent from the following detailed description, the drawings, and the claims.

### BRIEF DESCRIPTION OF DRAWINGS

FIG. 1 is a perspective view illustrating an example of a wireless charging system.

FIG. 2 is an exploded cross-sectional view illustrating an example of main components of the wireless charging system of FIG. 1.

FIG. 3 is a schematic cross-sectional view illustrating an example of a magnetic sheet.

FIG. 4 is an enlarged view illustrating an example of region A in the magnetic sheet of FIG. 3 before heat treatment.

FIG. 5 is a view illustrating an example of a process of manufacturing the magnetic sheet of FIG. 3.

FIGS. 6 and 7 are enlarged views respectively illustrating examples of regions A and B in the magnetic sheet of FIG. 3 after heat treatment.

FIG. 8 is graph illustrating results of an X-ray diffraction (XRD) analysis performed on an example of a magnetic layer before heat treatment.

FIGS. 9 and 10 are graphs respectively illustrating results of an XRD analysis performed on examples of a first surface region and a second surface region of the magnetic layer after heat treatment at various heat treatment temperatures.

FIG. 11 is an exploded cross-sectional view illustrating another example of the main components of the wireless power receiving apparatus of FIG. 2.

FIG. 12 is an exploded cross-sectional view illustrating another example of the main components of the wireless power receiving apparatus of FIG. 2.

FIG. 13 is a perspective view illustrating an example of a process of forming cracks in a method of manufacturing a magnetic sheet.

FIG. 14 is a plan view illustrating an example of a magnetic sheet having cracks formed by the process of FIG. 13.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

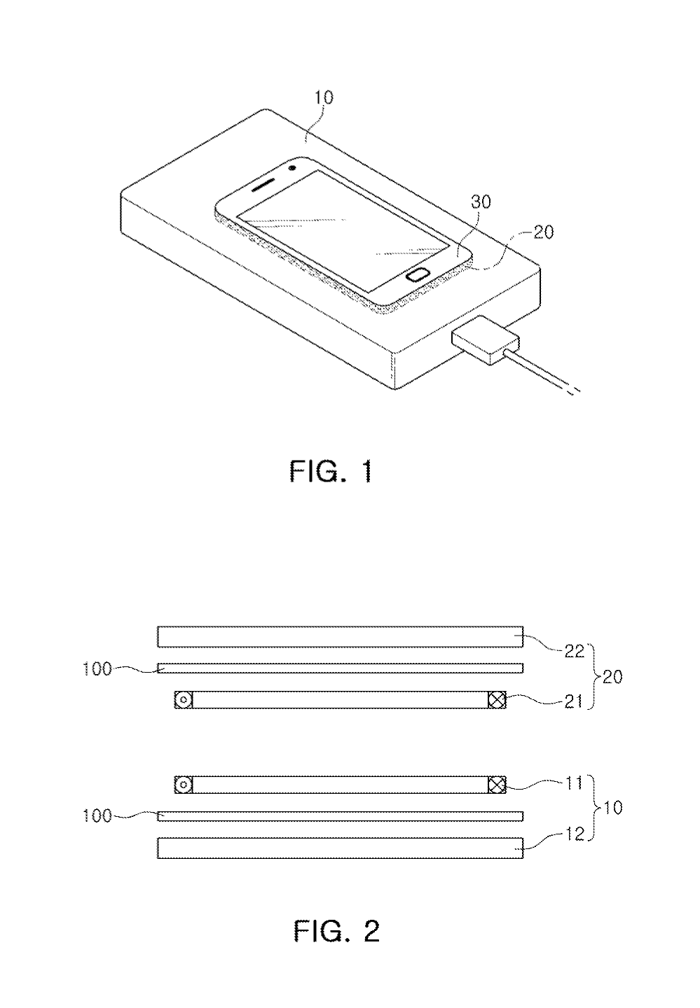

FIG. 1 is a perspective view illustrating an example of a wireless charging system, and FIG. 2 is an exploded cross-sectional view illustrating an example of main components of the wireless charging system of FIG. 1.

Referring to FIGS. 1 and 2, the general wireless charging system includes a wireless power transmitting apparatus 10 and a wireless power receiving apparatus 20. The wireless power receiving apparatus 20 is mounted in or on an electronic device 30 such as a mobile phone, a laptop computer, or a tablet personal computer (PC).

The wireless power transmitting apparatus 10 includes a transmission coil 11 formed on a substrate 12. Therefore, when an alternating current (AC) voltage is applied to the wireless power transmitting apparatus 10, a magnetic field is generated in the vicinity of the wireless power transmitting apparatus 10, causing electromagnetic coupling to occur between the transmission coil 11 and a reception coil 21 of the wireless power receiving apparatus 220. The electromagnetic coupling enables wireless power to be transmitted from the wireless power transmitting apparatus 10 to the wireless power receiving apparatus 20 to charge a battery 22 of the wireless power receiving apparatus.

The battery 22 may be a rechargeable battery, such as a nickel metal hydride battery or a lithium ion battery, but is not limited thereto. In addition, the battery 22 may be a separate element that is attachable to or detachable from the wireless power receiving apparatus 20, or may be an integral element of the wireless power receiving apparatus 20.

The transmission coil 11 and the reception coil 21 are electromagnetically coupled to each other during wireless power transmission, and may be formed by winding a metal wire made of copper or another electrical conductor to form a coil, or by forming a metal coil pattern on a substrate. However, these are merely examples, and the transmission coil 11 and the reception coil 21 may be formed in other ways. The transmission coil 11 and the reception coil 21 may have a circular shape, an oval shape, a quadrangular shape, a rhombic shape, or any other shape suitable for a desired application, and the size, the number of turns, the wire size, and other parameters of the transmission coil 11 and the reception coil 21 may be chosen to achieve desired properties.

A magnetic sheet 100 is disposed in the wireless power reception apparatus 20 between the reception coil 21 and the battery 22, and another magnetic sheet 100 is disposed in the wireless power transmission apparatus between the transmission coil 11 and the substrate 12. The magnetic sheet 100 disposed in the wireless power transmission apparatus 10 blocks a magnetic flux formed at a central portion of the transmission coil 11 from reaching the substrate 12. The magnetic sheet 100 disposed in the wireless power reception apparatus 20 concentrates a magnetic flux received from the transmission coil 11 to enable the magnetic flux to be efficiently received in the reception coil 21. In addition, the magnetic sheet 100 blocks at least some of the magnetic flux from reaching the battery 22.

As described above, the magnetic sheet 100 may be disposed facing a transmission coil in a wireless power transmitting apparatus and facing a reception coil in a wireless power receiving apparatus. In addition, the magnetic sheet 100 and the transmission coil or the reception may be used in a magnetic secure transmission (MST) apparatus, a near field communication (NFC) apparatus, and any other apparatus in which a magnetic field is transmitted or received. The transmission coil and the reception coil will hereinafter be referred to merely as a coil when they do not need to be distinguished from each other. The magnetic sheet 100 will hereinafter be described in more detail.

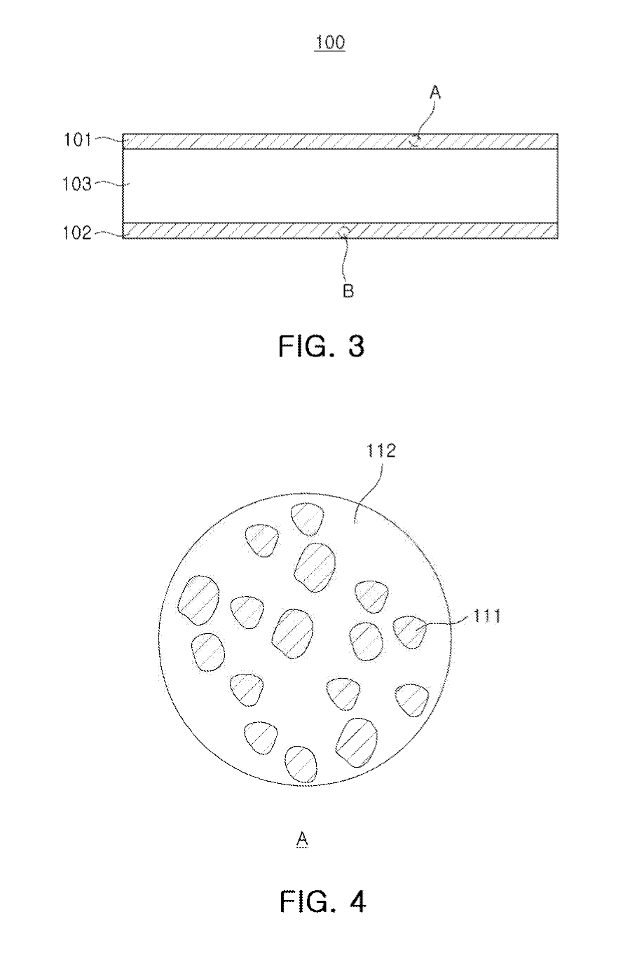

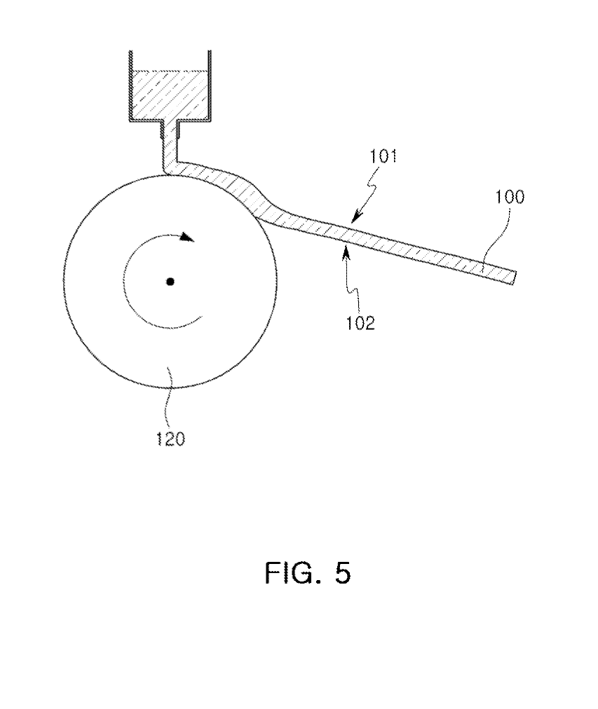

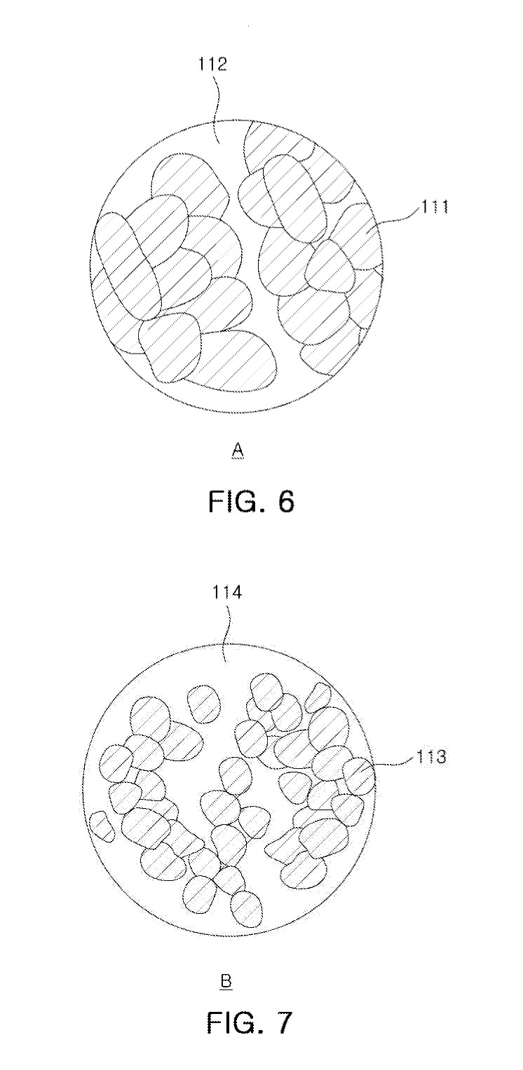

FIG. 3 is a schematic cross-sectional view illustrating an example of a magnetic sheet. FIG. 4 is an enlarged view illustrating an example of region A in the magnetic sheet of FIG. 3 before heat treatment. FIG. 5 is a view illustrating an example of a process of manufacturing the magnetic sheet of FIG. 3. FIGS. 6 and 7 are enlarged views respectively illustrating examples of regions A and B in the magnetic sheet of FIG. 3 after heat treatment.

Referring to FIG. 3, the magnetic sheet 100 includes one or more magnetic layers made of a metal, for example, one or more magnetic layers made of an Fe-based alloy. However, for simplicity, an example in which the magnetic sheet 100 includes only one magnetic layer will be described. In this example, since the magnetic sheet 100 includes only one magnetic layer, the magnetic sheet 100 will be referred as a magnetic layer 100, and thus the terms “magnetic layer” and “magnetic sheet” are synonymous with each other in this example. However, in the example of FIG. 12 described below, the magnetic sheet includes a plurality of magnetic layers 100 to improve a shielding effect.

The magnetic layer 100 is made of a material having magnetic properties effective for shielding electromagnetic waves, and in this example, the magnetic layer 100 is made of an Fe-based alloy. In detail, the magnetic layer 100 is made of an Fe-based nanocrystal grain alloy, and a detailed example of the Fe-based nanocrystal grain alloy will be described below. An amorphous metal obtained in a form such as a ribbon or other shape is heat treated at an appropriate temperature to obtain the Fe-based nanocrystal grain alloy.

In this example, the magnetic layer 100 includes a first surface region 101 and a second surface region 102 opposing each other in a thickness direction of the magnetic layer 100, and an internal region 103 disposed between the first surface region 101 and the second surface region 102. In addition, a crystallinity of the first surface region 101 is higher than a crystallinity of the second surface region 102. The crystallinities of the first surface region 101 and the second surface region 102 are different from each other when grain sizes, crystal distributions, and other properties of crystal grains in the first and second surface regions 101 and 102 are different from each other, and the term “crystallinities” refers to average sizes of crystal grains in the first and second surface regions 101 and 102. A thickness of each of the first and second surface regions 101 and 102 may vary depending on an overall thickness, a composition, a manufacturing process, and other parameters of the magnetic layer 100, and may be approximately ⅕ to 1/20 of a thickness of the magnetic layer 100, but is not limited thereto.

As described above, in this example, opposite surfaces of the magnetic layer 100 made of the Fe-based alloy have different crystallinities. For example, as illustrated in FIG. 4, before heat treatment, the region A of the first surface region 101 having a high crystallinity does not have a single phase structure of an amorphous phase 112, but has a mixed phase structure of crystal phases 111 and an amorphous phase 112. In contrast, although not illustrated in FIG. 4, before heat treatment, the second surface region 102 having a low crystallinity has a single phase structure of an amorphous phase 112 in which the crystal phases 111 of FIG. 4 do not exist at all in the second surface region 102, or a substantially single phase structure of an amorphous phase 112 in which a very small amount of the crystal phases 111 of FIG. 4 exist in the second surface region 102.

A process of manufacturing a metal ribbon, a composition of the Fe-based alloy, and other factors are controlled to make the crystallinities of the first and second surface regions 101 and 102 different from each other.

FIG. 5 illustrates an example of a method of forming the metal ribbon by quenching and solidifying a liquid-phase metal by flowing it onto a rotating wheel 120. Cooling speeds of a portion of the liquid-phase metal that is in contact with the wheel 120 and a portion of the liquid-phase metal that is not in contact with the wheel 120 are different from each other, producing a difference in crystallinity between the portion that is in contact with the wheel 120 and the portion that is not in contact with the wheel 120. In detail, since the second surface region 102 is in contact with the wheel 120 and is thus cooled at a relatively rapid speed, crystal grains are hardly formed in the second surface region 102 at the time of manufacturing an amorphous metal ribbon. On the contrary, since the first surface region 101 is relatively distant from the wheel 120 and thus is cooled at a speed lower than the cooling speed of the second surface region 102, a larger amount of crystal grains is formed in the first surface region 101 than in the second surface region 102 at the time of manufacturing the amorphous metal ribbon.

Such a trend regarding crystallinities also occurs when precipitating nanocrystal grains by heat treating the magnetic layer 100.

As illustrated in FIG. 6, the region A of the first surface region 101 after heat treatment has a mixed phase structure of crystal phases 111 and a partial amorphous phase 112 in which a ratio of a total area of the crystal phases 111 to an area of the region A is increased compared to the ratio in FIG. 4 before heat treatment because the crystal phases 111 grew in size during the heat treatment.

As illustrated in FIG. 7, the region B of the second surface region 102 after heat treatment has a mixed phase structure of precipitated crystal phases 113 and a partial amorphous phase 114, and the crystallinity of the second surface region 102 is lower than the crystallinity of the first surface region 101 because a ratio of a total area of the crystal phases 113 to an area of the region B is smaller than the ratio in region A of the first surface region 101. However, depending, for example, on the heat treatment conditions and a composition of the Fe-based alloy, in a case in which the second surface region 102 before heat treatment shown in FIG. 4 had a single phase structure of an amorphous phase 112 in which the crystal phases 111 did not exist at all in the second surface region 102, the region B of the second surface region 102 after heat treatment shown in FIG. 7 may have a single phase structure of an amorphous phase 114 without any precipitated crystal phases 113, or may have a substantially single phase structure of an amorphous phase 114 with only an inconsequential amount of precipitated crystal phases 113.

The difference in the crystallinity depending on a difference in a cooling speed occurs throughout the entire magnetic layer 100. The crystallinity of the internal region 103 disposed between the first and second surface regions 101 and 102 is different from the crystallinities of the first and second surface regions 101 and 102. In this example, the crystallinity of the internal region 103 is higher than the crystallinity of the second surface region 102 and lower than the crystallinity of the first surface region 101 because a cooling speed of the internal region 103 is lower than the cooling speed of the first surface region 101 not in contact with the wheel 120 and is higher than the cooling speed of the second surface region 102 in contact with the wheel 120. In general, the overall crystallinity of the magnetic layer 100 tends to gradually increase from the second surface region 102 to the first surface region 101.

In the magnetic layer 100 formed of the Fe-based alloy of this example, a saturation magnetic flux density (Bs) and a magnetic permeability of the magnetic layer 100 are improved by increasing the crystallinity of the first surface region 101 relative to the crystallinities of the second surface region 102 and the internal region 103. Therefore, an electromagnetic wave shielding or blocking effect of the magnetic layer 100 is improved. If the crystallinity were increased in the entire magnetic layer 100, a hysteresis loss and an eddy loss would increase. However, by locally increasing the crystallinity in the first surface region 101 in the magnetic layer 100 as described above, the hysteresis loss and the eddy loss is significantly less than it would be if the crystallinity were increased in the entire magnetic layer 100. Even if the magnetic layer 100 described above has a small thickness, it exhibits a high level of shielding performance, thereby contributing to miniaturization of the electronic device by enabling the thickness of the magnetic layer 100 to be reduced.

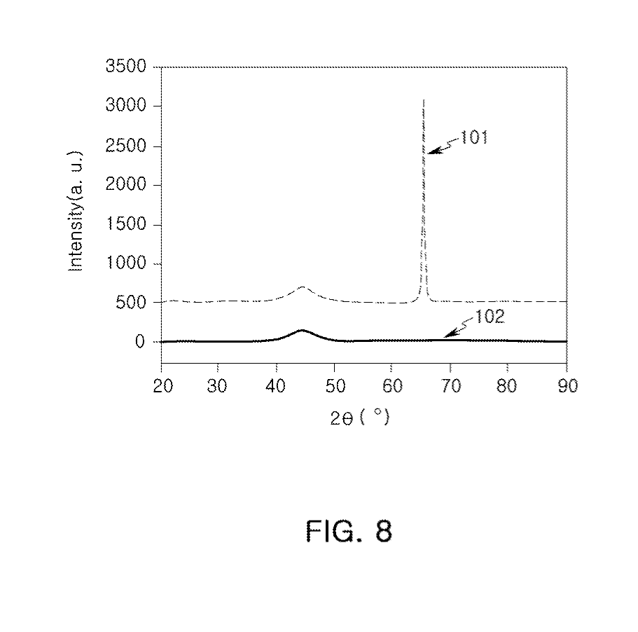

An X-ray diffraction (XRD) analysis of the magnetic layer has confirmed that crystal grains exist in the first surface region both before and after heat treatment as will be described with reference to FIGS. 8 through 10.

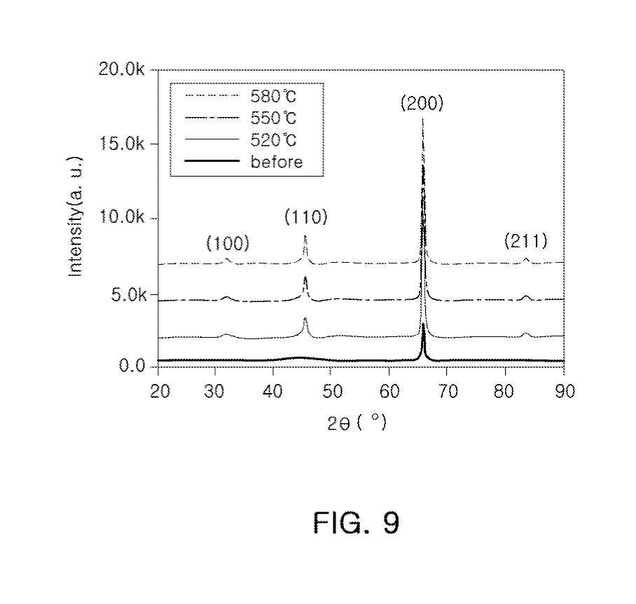

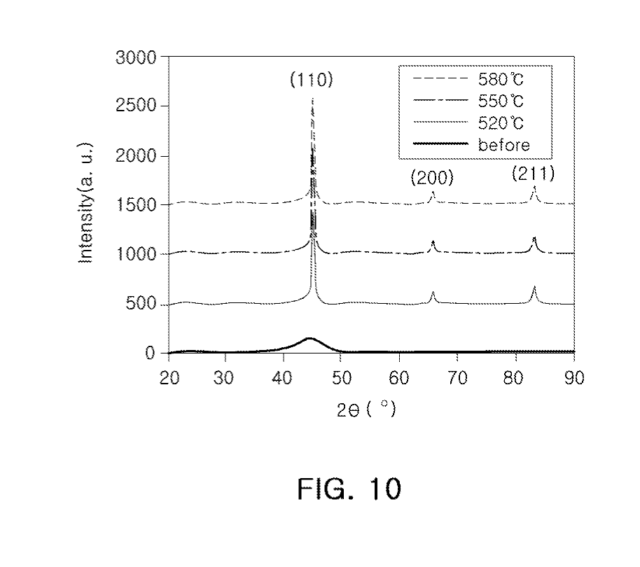

FIG. 8 is a graph of results of an XRD analysis performed on an example of a magnetic layer before heat treatment. FIGS. 9 and 10 are graphs respectively illustrating results of an XRD analysis performed on examples of a first surface region and a second surface region of the magnetic layer after heat treatment at various heat treatment temperatures.

First, as can be seen from FIG. 8, even before the heat treatment, a sharp peak was occurs in the vicinity of about 67° in the first surface region 101, but a sharp peak does not occur in the second surface region 102. In addition, as can be seen from FIGS. 9 and 10, that crystallinities of the first surface region 101 and the second surface region 102 are different from each other after heat treatment.

It can be seen that in the first surface region 101, a peak of a (200) plane is greater than a peak of a (110) plane, while in the second surface region 102, a peak of a (110) plane is greater than a peak of a (200) plane. In addition, it can be seen that in the first surface region 101, a main peak appears at the (200) plane, while in the second surface region 102, a main peak appears at the (110) plane. A main peak is a highest peak among all peaks in a region. Furthermore, it can be seen that the peak of the (200) plane in the first surface region 101 is about 17,000 arbitrary units (a.u.), while the peak of the (110) plane in the second surface region is about 2550 a.u. Thus, the peak of the (200) plane is about 6.67 times higher than the peak of the (110) plane. As a general rule, it is desirable that the peak of the (200) plane be at least 5 times higher than the peak of the (110) plane.

Thus, it can be seen that the crystallinity of the first surface region 101 is significantly different from the crystallinity of the second surface region 102 because the main peak appears at the (200) plane in the XRD analysis graphs of the first surface region 101 both before and after the heat treatment as described above.

The Fe-based alloy is represented by a composition formula of FeₓB_{y}Si_{z}M_{α}A_{β} in which M is at least one element selected from the group consisting of Nb, V, W, Ta, Zr, Hf, Ti, P, C and Mo, A is at least one element selected from the group consisting of Cu and Au, and x, y, and z expressed in atomic % satisfy the conditions 75%≤x≤90%, 7%≤y≤13%, and 4%≤z≤12%. Also, α and β expressed in atomic % satisfy the conditions 1.5%≤α≤3% and 0.1%≤β≤1.5% and correspond to the remainders.

Making the magnetic layer 100 from the Fe-based alloy having the composition described above enables the first surface region 101 to have a high crystallinity, thereby enabling the magnetic sheet 100 to have a high saturation magnetic flux and magnetic permeability. In addition, when the magnetic layer 100 is made of the Fe-based alloy having such a composition, the magnetic layer 100 exhibits an excellent shielding efficiency even at a small thickness.

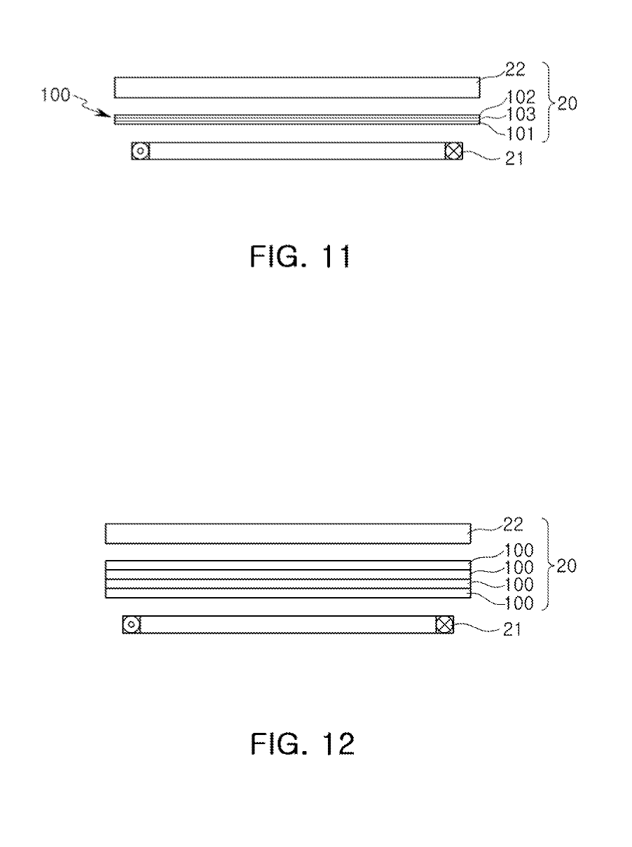

FIG. 11 is an exploded cross-sectional view illustrating another example of the main components of the wireless power receiving apparatus of FIG. 2.

Referring to FIG. 11, the magnetic sheet 100 is disposed so that the first surface region 101 faces toward the reception coil 21. When the magnetic sheet 100 is disposed so that the first surface region 101 having a high crystallinity enabling the magnetic sheet 100 to have a relatively excellent saturation magnetic flux density and magnetic faces the reception coil 21, a shielding efficiency of the magnetic sheet 100 is further improved.

FIG. 12 is an exploded cross-sectional view illustrating another example of the main components of the wireless power receiving apparatus of FIG. 2.

Referring to FIG. 12, the wireless power receiving apparatus 20 includes an electromagnetic wave shielding structure including a plurality of magnetic layers 100 each having the properties of the magnetic layer 100 described above. The number and thicknesses of the magnetic layers 100 may be determined based on a desired shielding performance and a desired thickness of the magnetic sheet.

Although not illustrated in FIG. 12, each of the magnetic layers 100 includes a first surface region 101 and a second surface region 102 opposing each other in the thickness direction of the magnetic layer 100, and an internal region 103 disposed between the first surface region 101 and the second surface region like the magnetic layer 100 of FIGS. 3 and 11. In each of the magnetic layers 100, the first surface region 101 may face toward the reception coil 21.

An example in which cracks are formed in a magnetic sheet will now be described.

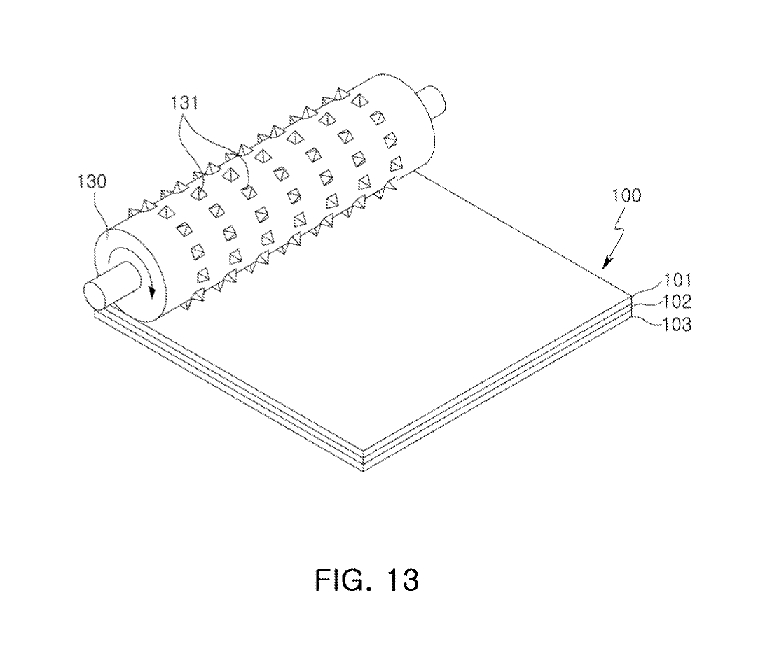

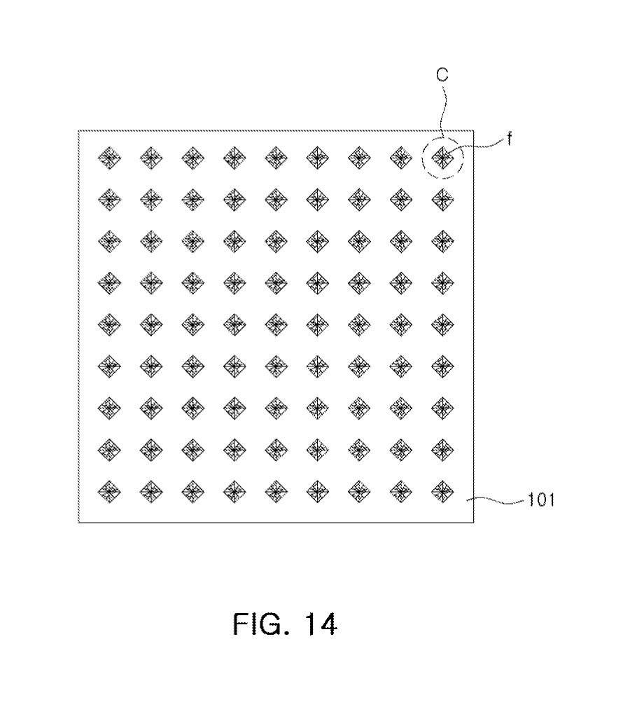

FIG. 13 is a perspective view illustrating an example of a process of forming cracks in a method of manufacturing a magnetic sheet, and FIG. 14 is a plan view illustrating an example of a magnetic sheet having cracks formed by the process of FIG. 13.

FIG. 13 illustrates an example of a process of forming cracks by applying a fragmentation tool constituted by a roller 130 to a surface of the magnetic sheet 100. The roller 130 is provided to form the cracks in the magnetic sheet 100, and has a plurality of protrusions 131 formed on a surface of a rotatable body. In the example illustrated in FIG. 13, the protrusions 131 have a square pyramid shape, but are not limited thereto, and may have a conical shape, a polygonal pyramid shape, a pillar shape, or any other shape as long as they protrude from the rotatable body and are capable of forming the cracks. The roller 130 having the protrusions 131 formed on the surface thereof forms cracks having a shape corresponding to the shape of the protrusions 131 in the magnetic sheet 100 while rolling along the magnetic sheet 100.

In the example illustrated in FIG. 13, the plurality of protrusions 131 have a regular form to form the cracks. The phrase “regular form” means that shapes, pitches, and an arrangement of the plurality of protrusions 131 are regular. For example, the plurality of protrusions 131 are regularly arranged in a state in which they are spaced apart from adjacent protrusions at a constant interval so that distances between the protrusions 131 are entirely uniform.

When the magnetic sheet 100 is manufactured using a fragmentation tool, such as the roller 130 of FIG. 13, to form cracks in the magnetic sheet 100, a structure of the magnetic sheet 100 can be easily controlled, so that magnetic characteristics of the magnetic sheet 100, such as a saturation magnetic flux density and a magnetic permeability, can be easily controlled, and a structural reproducibility and a stability of the magnetic sheet 100 can be improved.

In the example illustrated in FIG. 13, the roller 130 contacts the first surface region 101 of the magnetic sheet 100 to fragment the first surface region 101 to form cracks. The first surface region 101 having the high crystallinity is relatively uniformly fragmented by the roller 130, forming regular cracks in the first surface region 101. When a region having a high amorphicity and a low crystallinity, such as the second surface region 102 of the magnetic sheet 101, is fragmented to form cracks, it is difficult to effectively control a size and a shape of the cracks. Therefore, the magnetic sheet 100 having more uniform magnetic characteristics, such as a saturation magnetic flux density and a magnetic permeability, may be obtained by fragmenting the first surface region 101 having the high crystallinity to form cracks.

When the roller 130 having the form described above is applied to the magnetic sheet 100, a plurality of cracks C are formed in the magnetic sheet 100 as illustrated in FIG. 14. Since the protrusions 131 of the roller 130 have a constant interval therebetween, the plurality of cracks C also have a constant interval therebetween. The plurality of cracks C have a form in which a surface of the magnetic layer is fragmented. For example, as illustrated in FIG. 14, each of the plurality of cracks C includes a plurality of fragments f. At least some of the plurality of fragments f radiate from the center of the crack C. In other words, at least some of the plurality of fragments f have a shape that extends in a radial direction from a common point in the center of the crack C.

When the first surface region 101 is fragmented by the protrusions 131 of the roller 130, portions of the second surface region 102 opposing the first surface region 101 may also be fragmented depending on, for example, a length of the protrusions, a thickness of the magnetic sheet 100, and a downward pressure applied to the roller 130. In this case, the size and the shape of the cracks of the first and second surface regions 101 and 102 are different from each other, and the difference depends at least on the difference between the crystallinities of the first and second surface regions 101 and 102.

The examples of the magnetic sheet described above have excellent magnetic characteristics, such as a saturation magnetic flux density and a magnetic permeability, so that a shielding efficiency is improved when the magnetic sheet is used in an electronic device. In addition, the magnetic sheet has an excellent shielding efficiency even at a small thickness, thereby contributing to miniaturization of an electronic device in which the magnetic sheet is used and a significant improvement in space utilization in the electronic device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A magnetic sheet comprising:
a magnetic layer made of an Fe-based alloy,
wherein the magnetic layer comprises a first surface region and a second surface region opposing each other in a thickness direction of the magnetic layer, and an internal region disposed between the first surface region and the second surface region, and
a crystallinity of the first surface region is higher than a crystallinity of the second surface region.

2. The magnetic sheet of claim 1, wherein a crystallinity of the internal region is different from the crystallinity of the first surface region and the crystallinity of the second surface region.

3. The magnetic sheet of claim 1, wherein a crystallinity of the internal region is higher than the crystallinity of the second surface region.

4. The magnetic sheet of claim 3, wherein the crystallinity of the first surface region is higher than the crystallinity of the internal region.

5. The magnetic sheet of claim 4, wherein a crystallinity of the magnetic sheet gradually increases from the second surface region to the first surface region.

6. The magnetic sheet of claim 1, wherein the Fe-based alloy is represented by a composition formula of FeₓB_{y}Si_{z}M_{α}A_{β} in which M is at least one element selected from the group consisting of Nb, V, W, Ta, Zr, Hf, Ti, P, C, and Mo, A is at least one element selected from the group consisting of Cu and Au, and x, y, and z expressed in atomic % satisfy the conditions 75%≤x≤90%, 7%≤y≤13%, and 4%≤z≤12%.

7. The magnetic sheet of claim 1, wherein in the first surface region, a peak of a (200) plane is greater than a peak of a (110) plane in an X-ray diffraction (XRD) analysis graph.

8. The magnetic sheet of claim 7, wherein in the first surface region, a main peak appears at the (200) plane in the XRD analysis graph.

9. The magnetic sheet of claim 1, wherein in the second surface region, a peak of a (110) plane is greater than a peak of a (200) plane in an X-ray diffraction (XRD) analysis graph.

10. The magnetic sheet of claim 9, wherein in the second surface region, a main peak appears at the (110) plane in the XRD analysis graph.

11. The magnetic sheet of claim 1, wherein the first surface region has a mixed phase structure of crystal phases and an amorphous phase, and
the second surface region has a substantially single phase structure of an amorphous phase.

12. The magnetic sheet of claim 1, wherein the magnetic layer has a fragmented surface comprising a plurality of cracks.

13. The magnetic sheet of claim 12, wherein each of the plurality of cracks comprises a plurality of fragments.

14. The magnetic sheet of claim 12, wherein the fragmented surface is a surface of the first surface region.

15. An electronic device comprising:
a coil; and
a magnetic sheet disposed adjacent to the coil and comprising a magnetic layer made of an Fe-based alloy,
wherein the magnetic layer comprises a first surface region and a second surface region opposing each other in a thickness direction of the magnetic layer, and an internal region disposed between the first surface region and the second surface region, and
a crystallinity of the first surface region is higher than a crystallinity of the second surface region.

16. The electronic device of claim 15, wherein the magnetic sheet is disposed so that the first surface region faces toward the coil.

17. A magnetic sheet comprising:
a magnetic layer made of an Fe-based alloy and comprising a mixture of crystal phases and an amorphous phase,
wherein a ratio of a total area of the crystal phases to an area of the amorphous phase in a cross-sectional area of the magnetic layer changes in a thickness direction of the magnetic layer.

18. The magnetic sheet of claim 17, wherein the magnetic layer comprises a first surface region and a second surface region opposing each other in the thickness direction of the magnetic layer, and an internal region disposed between the first surface region and the second surface region, and
the ratio gradually decreases from the first surface region of the magnetic layer to the second surface region.

19. The magnetic sheet of claim 17, wherein the magnetic sheet is constituted by a single one of the magnetic layer.

20. The magnetic sheet of claim 17, wherein the magnetic sheet is constituted by a plurality of the magnetic layer.

21. A magnetic sheet comprising:
a magnetic layer made of an Fe-based alloy comprising a first surface region and a second surface region opposing each other in a thickness direction of the magnetic layer, and an internal region disposed between the first surface region and the second surface region,
wherein a highest peak in an X-ray diffraction (XRD) analysis graph for the first surface region occurs at a first plane,
a highest peak in an XRD analysis graph for the second surface region occurs at a second crystalline plane different from the first plane, and
the peak of the first plane in the first surface region is higher than the peak of the second plane in the second surface region.

22. The magnetic sheet of claim 21, wherein the peak of the first plane in the first surface region is at least 5 times higher than the peak of the second plane in the second surface region.

23. The magnetic sheet of claim 21, wherein a crystallinity of the magnetic layer gradually decreases from the first surface region to the second surface region.

24. The magnetic sheet of claim 21, wherein a saturation magnetic flux density and a magnetic permeability of the first surface region are higher than a saturation magnetic flux density and a magnetic permeability of the internal region and a saturation magnetic flux density and a magnetic permeability of the second surface region.
